(19) United States
(12) Patent Application Publication
(10) Pub. No.: US 2021/0183567 A1
(43) Pub. Date: Jun. 17, 2021

(54) RADIATION-ORIENTED SINTERED ARC-SHAPED ND-FE-B MAGNET, A MANUFACTURING METHOD THEREOF, AND A CORRESPONDING MANUFACTURING DEVICE

(71) Applicant: Yantai Shougang Magnetic Materials Inc, Yantai (CN)

(72) Inventors: Zhanji DONG, Yantai (CN); Zhongjie PENG, Yantai (CN); Xiaochen ZHAI, Yantai (CN); Kaihong DING, Yantai (CN)

(21) Appl. No.: 17/105,642

(22) Filed: Nov. 27, 2020

(30) Foreign Application Priority Data
Dec. 13, 2019 (CN) 201911286542.9

(51) Int. Cl. H01F 41/02; H01F 1/057; B22F 3/24; B22F 3/03

(52) U.S. Cl. CPC H01F 41/0266; H01F 1/0576; H01F 1/0577; B22F 2202/05; B22F 3/03; B22F 2003/248; B22F 2301/355; B22F 3/24

(57) ABSTRACT

The disclosure provides a method for preparing a radiation-oriented sintered arc-shaped Nd—Fe—B magnet. The method comprises: providing a Nd—Fe—B powder and a molding device; performing a first sub-step of align pressing including filling the arc-shaped cavity of the molding device with a first powder loading of the Nd—Fe—B powder, performing a first magnetization of the Nd—Fe—B powder, and mold pressing the Nd—Fe—B powder to form a first green body; performing a second sub-step of align pressing including filling the arc-shaped cavity of the molding device with a second powder loading of the Nd—Fe—B powder, performing a second magnetization of the Nd—Fe—B powder, and mold pressing the Nd—Fe—B powder to form a second green body; and sintering and annealing the second green body to obtain an arc-shaped Nd—Fe—B magnet. Further aspects of the disclosure are a molding device useful for the preparation method and a radiation-oriented sintered arc-shaped Nd—Fe—B magnet obtained by the method.

### TECHNICAL FIELD

The present disclosure relates to sintered Nd—Fe—B magnets and a corresponding manufacturing process thereof, in particular to a radiation-oriented sintered arc-shaped Nd—Fe—B magnet, a corresponding manufacturing process and a manufacturing device, which is useful for performing the manufacturing process.

### BACKGROUND

Servo motors with permanent magnet are widely used due to their high efficiency, low power dissipation and high precision. The permanent magnet inside is an important core component which determines the permanent magnet servo motor. At present, most servo motors use arc-shaped or plates parallel to the radial direction, which form the main body of the motor through interference with the rotor. However, this assembly method is likely to cause the motor to vibrate and noise.

In order to overcome the disadvantages of arc-shaped or plates parallel to the radial direction, some servo motors are assembled by means of radiating magnetic rings, which are mostly manufactured by isotropic bonded magnets or by a hot-pressing process. However, the presence of an adhesive inside the magnetic rings will cause a loss of magnetic energy, and hot-pressed products have a low magnetic consistency, yield rate and material utilization.

Some manufacturers have developed sintered Nd—Fe—B radial arc-shaped magnet or radial magnetic ring manufacturing processes. Although compared with hot-pressing process the magnetic performance is improved, the magnetic performance is still insufficient. In addition, the molding equipment is technically complex and expensive.

In addition, in known manufacturing methods of sintered Nd—Fe—B radial arc-shaped magnets, it is necessary to design special magnet forming and orientation equipment for products with different sizes of performance requirements separately, which leads to low flexibility, long design cycles, and single product brands.

For example, the CN107579628A discloses a method for manufacturing radially oriented rare earth permanent ferrite arc-shaped magnets. Although this method may improve the magnetic properties of the magnet, the forming equipment is technically extremely complicated, which is not useful for mass production.

Further, the methods known in the art for preparing the sintered Nd—Fe—B radial arc-shaped magnets still have the problem that the magnetic properties are not uniform, and the remanence at the corners of the magnets is lower than in the middle part. For example, CN 203209691A discloses an Nd—Fe—B radiation orientation magnet mold, which is characterized in that magnetic side plates are respectively arranged in the mold cavity to form a radial orientation magnetic field. The main disadvantage of this method is that the position, where the included angle of the mold cavity is relatively large, will cause the magnetic field orientation to deteriorate, resulting in reduced performance of the angled part of the magnet.

Furthermore, the existing sintered Nd—Fe—B radiation oriented magnetic ring or arc has poor powder fluidity during the molding and orientation process, and compaction density deviation exists in the vertical height direction of the green body, which is easy to break during the demolding process. To solve the above problems, CN 1173028B discloses a pre-forming device for a green body, and by adding a thermosetting resin to the powder, the mold is heated and formed. A main drawback of the method is that the Nd—Fe—B powder is easily oxidized by heating, and residual material reduces the magnetic properties significantly.

CN 110415964B discloses a method for preparing a Nd—Fe—B multi-pole magnetic ring. The surface-modified anisotropic powder and paraffin are mixed, and the magnetic powder is pre-pressed to form a preformed body. Although this method addresses the orientation stability problem, the addition of paraffin wax will inevitably cause deterioration of the magnet performance.

CN 103971917B adopts a method of applying pre-forming pressure to first prepare a pre-shaped magnetic ring. The method may improve the density consistency of the magnetic ring and increase the yield. However, the patent does not limit the weight of the powder during preforming, or in other words, it does not divide the powder into multiple powder feeds. The reason for paying attention to the weight of the powder in the pre-forming process is that when a magnet with a relatively large compacting height is produced, the orientation of the green body or the consistency of the density can only be improved to a limited extent. However, the alignment consistency of the radial arc-shaped magnet or the magnetic ring may still be poor.

### SUMMARY OF THE DISCLOSURE

The present disclosure provides a preparation method for a radiation-oriented sintered arc-shaped Nd—Fe—B magnet having improved overall magnetic performance, and a high Nd—Fe—B main phase orientation. Further. The cracking rate of green bodies during the manufacturing process is reduced.

The remanence of Nd—Fe—B magnets mainly comes from the main phase, that is, the 2:14:1 phase (e.g. Nd₂Fe₁₄B₁). When the composition of the magnet is determined, the main factors that affect the remanence of the sintered Nd—Fe—B magnet roughly include the orientation of the main phase, the proportion of the main phase in the magnet, and the density of the magnet. The latter two parameters are greatly affected by sintering and annealing process. The first parameter is greatly affected by the molding orientation process. When the particle size of the powder and the amount of lubricant added are set up, the orientation of the powder is determined by the magnetic alignment field. The higher degree of orientation of the powder, the higher gets the degree of orientation of the main phase of the final magnet, resulting in the higher remanence of the magnet.

However, for radiation-oriented sintered arc-shaped Nd—Fe—B magnet, when the powder is oriented and pressed in the forming magnetic field to form a green body, the applied external magnetic field either cannot reach the same magnetic field range as a conventional parallel magnetic field or the angle θ between the orientation angle and the actual value deviates, and the larger the angle θ, the lower is the remanence of the magnet. When testing the magnetic surface field distribution of the magnet, the surface field distribution curve will fluctuate. In addition to the impact on magnetic properties, the green body may break due to uneven molding pressure and orientation during the manufacturing process.

One aspect of the present disclosure is to solve the problems of inconsistency of the orientation field between the two edges and the centre of the arc-shaped magnet, and the deviation between the actual direction of the magnetic field and the design direction.

Specifically, a molding device for the align pressing step of a manufacturing process of a radiation-oriented sintered arc-shaped Nd—Fe—B magnet is provided. The molding device including a mold body comprising:

a) a mold main body provided with an arc-shaped cavity including a concave inner arc surface and a convex outer arc surface;

b) a first and a second magnetic conductive block located on both sides of the arc-shaped cavity, the first magnetic conductive block being located on the side of the inner arc surface, and the second magnetic conductive block being located on the side of the outer arc surface, wherein the centre points of the first magnetic conductive block, the arc-shaped cavity and the second magnetic conductive block lie on a common straight line; and

c) two symmetrically distributed uniform magnetic conductive plates being arranged between the outer arc surface of the arc-shaped cavity and the second magnetic conductive block.

In other words, a radiation-oriented sintered arc-shaped Nd—Fe—B magnet molding device is provided, which includes a non-magnetically conductive mold body, a mold cavity, a magnetically conductive component, and a magnetically conductive plate. The mold body is provided with a mold cavity, the mold cavity is arc-shaped, both sides are curved arc surfaces, the inner arc surface is an inwardly concave arc surface, and the outer arc surface is an outwardly protruding arc surface, The magnetic conductive component is two magnetic conductive blocks located on both sides of the mold cavity, and the first magnetic conductive block is located on one side of the inner circular arc surface of the arc shape. The second magnetic permeable block is located on the side of the outer arc surface of the arc shape, wherein the centre points of the first magnetic permeable block, the arc-shaped mold cavity, and the second magnetic permeable block are on the same straight line. Two symmetrically distributed uniform magnetic conductive plates are arranged between the outer circular arc surface and the second magnetic conductive block.

According to one embodiment, a surface of the first magnetic conductive block facing the inner arc surface is arc-shaped, and a radius of the arc shape is smaller than a radius of the inner arc surface in the arc-shaped cavity.

According to another embodiment, a surface of the second magnetic conductive block facing the outer arc surface is bent, and a bending angle of the bent shape is 90 degrees. The arc-shaped mold cavity may be located in the space radiated by the bent surface of the second magnetic conductive block.

According to another embodiment, the two magnetic conductive plates are respectively located at the two ends of the outer arc surface of the arc-shaped cavity. A centre point of each magnetic plate may be located on the extension line of the radius of the arc-shaped mold cavity.

According to another embodiment, a thickness W of the magnetic conductive plate satisfies the condition: 0.5 cavity thickness ≤W≤1.0 mold cavity thickness, a length L of the magnetic conductive plate satisfies the condition: 0.2 inner arc length ≤L≤0.4 inner arc length, where the inner arc length L is the length of the inner arc surface of the arc-shaped cavity, a side surface of the arc-shaped cavity is on the same plane as an outer side surface of the magnetic conductive plate, and a thickness of the arc-shaped cavity is in the range of 5 mm to 25 mm.

According to another embodiment, the molding device further includes an upper indenter and a lower indenter. The upper indenter being located directly above the arc-shaped cavity and the lower indenter being located directly below the arc-shaped cavity.

Another aspect of the present disclosure is to solve the problems of uneven up-and-down orientation and molding fracture of the above-mentioned magnets. Specifically, it provides a method for preparing a radiation-oriented sintered arc-shaped Nd—Fe—B magnet. The method comprises in that order the steps of:

a) providing a Nd—Fe—B powder and the molding device as defined above;

b) performing a first sub-step of align pressing including filling the arc-shaped cavity of the molding device with a first powder loading of the Nd—Fe—B powder, performing a first magnetization of the Nd—Fe—B powder, and mold pressing the Nd—Fe—B powder to form a first green body;

c) performing a second sub-step of align pressing including filling the arc-shaped cavity of the molding device with a second powder loading of the Nd—Fe—B powder, performing a second magnetization of the Nd—Fe—B powder, and mold pressing the Nd—Fe—B powder to form a second green body; and

d) sintering and annealing the second green body to obtain an arc-shaped Nd—Fe—B magnet.

According to one embodiment of the method, in step b) a weight w1 of the first powder loading satisfies the relation: 0.2M≤w1≤0.5M, where M is the weight of the second green body; a magnetic field T1 of the first magnetization satisfies the relation: 0.1 Tesla≤T1≤0.3 Tesla; and a density p1 of the first green body after the mold pressing satisfies the relation: 0.8P≤p1≤0.9P, where P is the density of the second green body and P satisfies the condition 3.8 g/cm³≤P≤4.5 g/cm³.

According to another embodiment of the method, in step c) a weight w2 of the second powder loading is w2=M−w1; and a magnetic field T2 of the second magnetization satisfies the relation: 0.3 Tesla<T2≤2.5 Tesla.

Another aspect of the present disclosure refers to a radiation-oriented sintered arc-shaped Nd—Fe—B magnet obtained by the above-mentioned method. The radiation-oriented sintered arc-shaped Nd—Fe—B magnet may have an orientation degree of the main phase of the sintered Nd—Fe—B arc-shaped magnet above 92%. An orientation angle of the radiation orientation and a target value deviate may be Δθ≤1 degree, and an overall residual deviation of the magnet may be ΔBr≤2%.

This may result in the following advantages:

By adopting the manufacturing process, in particular performing powder feeding twice and forming twice, and controlling the weight of each powder feeding and the size of the orientation field within a reasonable range, the problems of uneven top and bottom orientation and green body cracking can be solved. The molding device of the present application utilizes the homogenized magnetic conductive plate added therein, and its size and angle are designed reasonably, so that the direction of the magnetic field of the arc mold cavity is consistent with the design value under the condition of increasing the applied orientation field, thereby improve the remanence uniformity of arc-shaped Nd—Fe—B magnet.

### BRIEF DESCRIPTION OF THE FIGURES

FIG. 1 is a schematic diagram of the molding device according to an embodiment of the present disclosure.

### MARKING DESCRIPTION

1. The first magnetically permeable block;
2. The main body of the mold;
3. The cavity;
4. The symmetrically distributed uniform magnetic conductive plate;
5. The direction of the magnetic force line;
6. The inner arc surface;
7. The second magnetically permeable block;
8. The outer arc surface.

### DETAILED DESCRIPTION OF THE DISCLOSURE

The following is a detailed description of the present disclosure in combination with specific embodiments. The examples are only used to explain the present disclosure, and do not have any limiting effect on it.

The below manufacturing process leads to a radiation-oriented sintered arc-shaped Nd—Fe—B magnet meeting the following characteristics: the orientation degree of the main phase is above 92%, the orientation angle of the radiation direction and the target value deviation is Δθ≤1 degree, and the remanence deviation of the overall magnet is ΔBr≤2%.

Nd—Fe—B alloy flakes for the manufacturing process may be prepared by a strip casting process, and then subjected to hydrogen decrepitation and jet milling process to obtain a Nd—Fe—B alloy powder. The magnet powder can be freshly made by using currently well-known or recognized sintered Nd—Fe—B powder preparation methods or it can be a commercially available Nd—Fe—B powder.

In particular, the Nd—Fe—B alloy may have the composition REₐ-T_{(1-a-b-α)}—B_{b}-M_{c}, where a, b, and c respectively represent the mass percentages, and RE is a rare earth element selected from at least one of Pr, Nd, Dy, Tb, Ho, and Gd, T is at least one of Fe or Co, B is element B, and M is metal selected from at least one of Al, Cu, Ga, Ti, Zr, Nb, Mo, and V. The specific content of these compounds may be 28%≤a≤32%, 0.8%≤b≤1.2%, and c≤5%.

The Nd—Fe—B powder is filled into a radiation-oriented mold cavity for align pressing. The powder is then oriented with an external magnetic field and pressed into the desired shape in an align pressing process step. The align pressing step thus includes the tasks of powder loading, magnetization and press molding. According to the present disclosure, align pressing is carried out twice, i.e. by a first sub-step of align pressing followed by a second sub-step of align pressing.

The first sub-step of align pressing includes powder loading, magnetization and pre-pressing: Nd—Fe—B powder according to a predetermined weight w1 is put it into the radiation-oriented mold cavity of a DC magnetic field press, the magnetic field is adjusted, and a molding pressure is applied to form a first green body.

The second sub-step of align pressing includes powder loading, magnetization and final molding: Nd—Fe—B powder according to a predetermined weight w2 is put it into the radiation-oriented mold cavity of the DC magnetic field press, the magnetic field is adjusted again, and a molding pressure is applied to form a second green body.

The second green body is then sintered and annealed under common conditions to obtain the required radiation orientation Nd—Fe—B arc-shaped magnet.

The radiation-oriented mold cavity in this application can be realized by using a DC magnetic field compressor or a pulsed magnetic field.

Through experiments, it is found that due to the small size of most arc-type products, the corresponding mold cavity size is generally smaller than of a conventional square magnet. This may lead to an insufficient flowability or distribution of the powder with the indenter when the arc-type magnet is formed. If an orientation and forming process similar to that of a square magnet is used, the green body may be oriented unevenly, and the green body may break after molding. It has been found that the problem can only be solved by adopting the process parameters as follows.

The weight w1 of the first powder loading may satisfy the relationship:

0.2M≤w1≤0.5M, where M is the weight of the finished block, i.e. the second green body. This is because when the first feeding weight is greater than 0.5M, the green body begins to exhibit uneven vertical orientation. When the first feeding weight is less than 0.2M, pre-compression is insufficient. When the compaction density after pre-compression (i.e. after the first sub-step of align pressing) is too high, the green body may break more easily in the second sub-step of align pressing. When the compaction density is too low, it cannot play the role of pre-compression. Therefore, the density p1 of the first green body should be 0.8P≤p1≤0.9P, where P is the relative density of the final (i.e. second) green body.

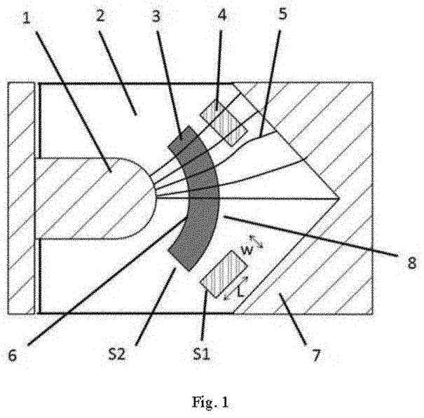

As shown in FIG. 1, the molding device for arc-shaped magnet includes a non-magnetically conductive mold body 2, an arc-shaped mold cavity 3, wherein the two curved arc surfaces of the mold cavity 3 have the same central inner arc surface and an outer arc surface, the arc surface of the inner arc surface is recessed inward, and the arc surface of the outer arc surface protrudes outward. In other words, the curvature of the inner and outer arc surface is equal. The molding device may be radially orientated DC (Direct Current) magnetic field press mold cavity.

The molding device also includes upper and lower pressure indenters (not shown), and magnetic permeable blocks on both sides of the mold cavity. Specifically, the molding device includes a first magnetic permeable block 1 and a second magnetic permeable block 7. An end of the first magnetic permeable block 1 facing the inner arc surface of the cavity 3 has a round arc shape, a side surface of the second magnetic conductive block 7 facing the outer arc surface of the cavity 3 is bent, and in this embodiment, it is bent at 90 degrees. The two sides of the bending are symmetrical.

The centre of the arc-shaped end of the first magnetic conductive block 1 is on the same straight line with the bending centre of the second magnetic conductive block 7 and the centre of the cavity 3. The radius of the arc-shaped end of the magnetic block 1 is smaller than the radius of the arc surface in the inner arc surface of the cavity 3.

Two symmetrically placed uniform magnetic conductive plates 4 are arranged between the outer arc surface of the arc-shaped mold cavity 3 of the molding device and the second magnetic conductive block 7.

The side surfaces connecting the inner arc surface and the outer arc surface are denoted as S2, and the side surfaces of the plate 4 close to the side wall of the mold body are denoted as S1. The centres of the two plates 4 are located in the extension of the cavity radius. A side surface S1 of the plate 4 and a side surface S2 of the arc-shaped cavity 3 lie on the same plane. The magnetic conductive plates 4 are located in the same manner at both ends of the outer arc of the arc-shaped mold cavity 3.

A thickness W of the homogenized magnetic conductive plate 4 satisfies the condition: 0.5 cavity thickness ≤W≤1.0 cavity thickness, and its length L satisfies the condition: 0.2 inner arc length ≤L≤0.4 inner arc length, where the arc length is the length of the inner arc surface of the arc-shaped cavity 3, and the cavity thickness is 5 mm to 25 mm.

The purpose of arranging two symmetrical homogenized magnetic conductive plates is to attract the magnetic lines of force on both sides of the arc, so that their directions are consistent with the design of the magnetic field, so that the angle of θ is less than or equal to 1 degree.

Although the two ends of the cavity of the radiating arc mold are respectively provided with magnetic conductive components, the magnetic lines of force form an ideal radial shape and pass through the cavity. However, as the intensity of the applied magnetic field increases, the magnetic field lines begin to tend to be straight, flowing from the N pole to the S pole of the press. On the left and right sides (edge parts) of the arc cavity, the normal lines of the magnetic field lines and the arc are no longer at 90 degrees.

This leads to a contradictory problem, that is, if the orientation field is increased, the orientation angle of the edge part of the arc cavity will deviate, the remanence of the magnet will be reduced, and the performance consistency of the magnet will deteriorate. In order to increase the orientation angle and consistency, it is necessary to reduce the orientation magnetic field, which will also reduce the remanence of the magnet and deteriorate the consistency of performance.

Using the molding device of the present disclosure, set up with the added homogenizing magnetic conductive plate and reasonably designing its size and angle, it is possible to make the direction of the magnetic field line of the arc-shaped cavity consistent with the design value under the condition of increasing the external orientation field. Thereby this kind of design will improve the remanence consistency of the magnet.

The reasonable design of the size and angle here means that if the length L of the homogenizing magnetic conductive plate 4 is too small, it will not be able to correct the magnetic force line, and the remanence at the edge of the tile will still be lower than the centre, and if the length L is too large, the magnetic field lines at the centre of the arc will be affected by the uniform magnetic sheet, resulting in too low remanence in the middle of the arc-shaped magnet.

In addition, the effect of too large and too small widths W of the homogenized magnetic conductive sheet is similar to that of length L. Too much widths W will cause the magnetic field lines to tilt toward the edge of the arc, and the remanence at the edge of the arc will be higher, while if the widths W is too small, it will not improve the role of magnetic field lines. Therefore, the ranges of L and W are respectively set as W satisfies the condition: 0.5 cavity thickness ≤W≤1.0 cavity thickness, L satisfies the condition: 0.2 inner arc length ≤L≤0.4 inner arc length, and the side surface S1 is on the same plane as the outer side surface S2 of the arc-shaped cavity.

To illustrate the disclosure, exemplary arc-shaped sintered Nd—Fe—B magnets are manufactured according to below Examples 1 through 3. For comparison, Comparative Examples 1 through 3 are added.

For ease of description, the following examples in this application are based on the total amount of 50 g Nd—Fe—B powder. The thickness of the arc-shaped cavity is 11 mm and the inner arc length of the cavity is 40 mm.

Different magnetic fields are used for alignment of the magnetic powder in the mold cavity. The density p1 of the first green body generated in the first sub-step of align pressing shall be about 3.4 g/cm³ and the density P of the second green body generated in the second sub-step of align pressing shall be about 4.2 g/cm³. The density values of p1 and P are not affected by the thickness of the cavity. The influence of the magnetic field is determined by the molding pressure brought by the molding device, and the performance of the magnets are compared under the same density condition.

The conditions for forming the second green body from 50 g magnetic powder (weight M) are:

The first weighted portion is in the range of 0.2M≤w1≤0.5M, i.e. w1 is in the range of 10 g to 25 g.

The second weighted portion is w2=M−w1.

The magnetic flux density T1 during the first sub-step of align pressing is in the range of 0.1 Tesla≤T1≤0.3 Tesla.

The density p1 of the first green body obtained by the first sub-step of align pressing is in the range of 0.8P≤p1≤0.9P, wherein P is the density of the second green body obtained by the second sub-step of align pressing and P is in the range of 3.8 g/cm³≤P≤4.5 g/cm³.

The magnetic flux density T2 during the second sub-step of align pressing is in the range 0.3 Tesla<T2≤2.5 Tesla.

The thickness of the cavity is 5 mm to 25 mm and the thickness W of the magnetic conductive plate is calculated according to the thickness of the cavity to be between 2.5 to 25 mm, i.e. 0.5 cavity thickness ≤W≤1.0 cavity thickness.

The length L of the magnetic conductive plate is in the range of 0.2 inner arc length ≤L≤0.4 inner arc length, the inner arc length is smaller than the width of the mold body and used in conjunction with the size of the cavity thickness.

### Example 1

The arc-shaped magnet is prepared as follows:

1) Prepare Nd—Fe—B powder with a composition of (PrNd)₃₂—Co_{1.0}—Al_{0.1}—Cu_{0.1}—Ti_{0.1}—B_{1.0}—Fe_{bal} in wt. %;

2) Weigh the powder with w1=20 g;

3) Put the weighed powder into the arc-shaped mold cavity, where the thickness of the cavity is 11 mm, the inner arc length is 40 mm, and the length L of the homogenized magnetic conductive plate is 10 mm and W is 8 mm;

4) The upper and lower indenters of the forming device extrude the mold cavity and set the magnetic field to 0.1 Tesla;

5) Adjust the molding pressure provided by the molding device so that the relative density of the green body is 3.4 g/cm³;

6) Remove the external magnetic field and move the pressure head away from the cavity;

7) Weigh w2=30 g powder for the second time and place it in the arc-shaped cavity again;

8) The upper indenter and the lower indenter extrude the cavity, and set the magnetic field to 1.0 Tesla;

9) Adjust the forming pressure to make the relative density of the green body 4.2 g/cm³;

10) Demoulding, placing the green body in a sintering furnace for sintering after isostatic pressing, and then annealing in the subsequent furnace;

11) The magnetic properties, orientation and angle difference θ of the centre and edge positions of the arc blanks after annealing are measured by a DC magnetic performance measuring instrument and an EBSD (electron backscatter diffractometer) respectively.

In Example 1, w1 is 20 g, the mold cavity thickness is 11 mm, the inner arc length is 40 mm, the magnetic plate length L is 10 mm, the magnetic plate thickness W is 8 mm, and the first magnetic field T1 is 0.1 Tesla, p1 is 3.4 g/cm³, w2 is 30 g, the second magnetic field T2 is 1.0 Tesla, and the P density is 4.2 g/cm³.

### Example 2

The arc-shaped magnet is prepared as follows:

1) Prepare Nd—Fe—B powder with a composition of (PrNd)₃₂—Co_{1.0}—Al_{0.1}—Cu_{0.1}—Ti_{0.1}—B_{1.0}—Fe_{bal} in wt. %;

2) Weigh the powder with w1=25 g;

3) Put the weighed powder into the arc-shaped mold cavity, where the thickness of the cavity is 11 mm, the inner arc length is 40 mm, and the length L of the homogenized magnetic conductive plate is 10 mm and W is 8 mm;

4) The upper and lower indenters of the forming device extrude the mold cavity and set the magnetic field to 0.2 Tesla;

5) Adjust the molding pressure provided by the molding device so that the relative density of the green body is 3.4 g/cm³;

6) Remove the external magnetic field and keep the pressure head away from the cavity;

7) Weigh w2=25 g powder for the second time and place it in the arc-shaped cavity again;

8) The upper indenter and the lower indenter extrude the cavity, and set the magnetic field to 1.5 Tesla;

9) Adjust the forming pressure to make the relative density of the green body 4.2 g/cm³;

10) Demoulding, placing the green body in a sintering furnace for sintering after isostatic pressing, and then annealing in the subsequent furnace;

11) The magnetic properties, orientation and angle difference θ of the centre and edge positions of the arc blanks after annealing are measured by a DC magnetic performance measuring instrument and an EBSD respectively.

The parameter selection range is similar to that of Example 1, but in terms of specific values, w1 is 25 g, the cavity thickness is 11 mm, the inner arc length is 40 mm, the magnetic plate length L is 10 mm, and the magnetic plate thickness W is 8 mm. The first magnetic field T1 is 0.2 Tesla, p1 is 3.4 g/cm³, w2 is 25 g, the second magnetic field T2 is 1.5 Tesla, and the P density is 4.2 g/cm³.

### Example 3

The arc-shaped magnet of Example 3 is prepared in the same manner as Example 2 except that the thickness of the cavity is 8 mm.

### Comparative Example 1

In Comparative Example 1, powder filling, magnetizing, and molding were performed only once, and 50 g powder was taken in a single time. Placed in the same environment as in Example 1, the thickness of the mold cavity was 8 mm, the inner arc length was 40 mm, and the length of the magnetic conductive plate L is 10 mm and W is 8 mm; only 1.5 Tesla is provided for the primary magnetic field, which is larger than the value of Ti in Example 1, but within the value range of T2, the resulting density is 4.2 g/cm³.

1) Prepare Nd—Fe—B powder with a composition of (PrNd)₃₂—Co_{1.0}—Al_{0.1}—Cu_{0.1}—Ti_{0.1}—B_{1.0}—Fe_{bal} in wt. %;

2) Weigh the powder with w1-50 g;

3) Put the weighed powder into the arc-shaped mold cavity, where the thickness of the cavity is 8 mm, the inner arc length is 40 mm, and the length L of the homogenized magnetic conductive plate is 10 mm and W is 8 mm;

4) The upper and lower indenters of the forming device extrude the mold cavity and set the magnetic field to 1.5 Tesla;

5) Adjust the molding pressure provided by the molding device so that the relative density of the green body is 4.2 g/cm³;

6) Remove the external magnetic field and keep the pressure head away from the cavity;

7) Demoulding, placing the green body in a sintering furnace for sintering after isostatic pressing, and then annealing in the subsequent furnace;

8) The magnetic properties, orientation and angle difference θ of the centre and edge positions of the arc blanks after annealing are measured by a DC magnetic performance measuring instrument and an EBSD respectively.

### Comparative Example 2

In Comparative Example 2, the powder loading, magnetization and molding process were carried out twice. The weight was the same as that of Example 1. It was placed in the same environment as Example 1. The thickness of the mold cavity was 8 mm, the inner arc length was 40 mm, and W was 8 mm. But the length L of the magnetic conductive plate is changed from 10 mm to 30 mm; the first magnetic field is 1.5 Tesla, and the generated density is 3.1 g/cm³. The second magnetic field is 1.5 Tesla, and the generated density is 4.2 g/cm³.

1) Prepare powder with a composition of (PrNd)₃₂—Co_{1.0}—Al_{0.1}—Cu_{0.1}—Ti_{0.1}—B_{1.0}—Fe_{bal} in wt. %;

2) Weigh the powder with w1=20 g;

3) Put the weighed powder into the arc-shaped mold cavity, where the thickness of the cavity is 11 mm, the inner arc length is 40 mm, and the length L of the homogenized magnetic conductive plate is 30 mm and W is 8 mm;

4) Close the indenter and set the magnetic field to 1.5 Tesla;

5) Adjust the molding pressure provided by the molding device so that the relative density of the green body is 3.4 g/cm³;

6) Remove the external magnetic field and keep the pressure head away from the cavity;

7) Weigh w2=30 g powder for the second time and place it in the arc-shaped cavity again;

8) The upper indenter and the lower indenter extrude the cavity, and set the magnetic field to 1.5 Tesla;

9) Adjust the forming pressure to make the relative density of the green body 4.2 g/cm³;

10) Demoulding, placing the green body in a sintering furnace for sintering after isostatic pressing, and then annealing in the subsequent furnace;

11) The magnetic properties, orientation and angle difference θ of the centre and edge positions of the arc blanks after annealing are measured by a DC magnetic performance measuring instrument and an EBSD respectively.

### Comparative Example 3

In Comparative Example 3, the powder loading, magnetization and molding process were carried out twice, and a total of 50 g powder was taken and placed in the same environment as in Example 1. The thickness of the mold cavity was 8 mm, and the inner arc length was 40 mm, but there was no magnetic conductive plate; the magnetic field is 0.1 Tesla, which is the same as T1 in Example 1, and the second magnetic field is 1.0 Tesla, which is the same as T2 in Example 1, and the resulting density is 4.2 g/cm³.

1) Prepare powder with a composition of (PrNd)₃₂—Co_{1.0}—Al_{0.1}—Cu_{0.1}—Ti_{0.1}—B_{1.0}—Fe_{bal} in wt. %;

2) Weigh the powder with w1=20 g;

3) Put the weighed powder into the arc-shaped mold cavity, where the thickness of the cavity is 11 mm, the inner arc length is 40 mm, no conductive plate set up;

4) Close the indenter and set the magnetic field to 0.1 Tesla;

5) Adjust the molding pressure provided by the molding device so that the relative density of the green body is 3.4 g/cm³;

6) Remove the external magnetic field and keep the pressure head away from the cavity;

7) Weigh w2=30 g powder for the second time and place it in the arc-shaped cavity again;

8) The upper indenter and the lower indenter extrude the cavity, and set the magnetic field to 1.0 Tesla;

9) Adjust the forming pressure to make the relative density of the green body 4.2 g/cm³;

10) Demoulding, placing the green body in a sintering furnace for sintering after isostatic pressing, and then annealing in the subsequent furnace;

11) The magnetic properties, orientation and angle difference θ of the centre and edge positions of the arc blanks after annealing are measured by a DC magnetic performance measuring instrument and an EBSD respectively.

Analysis of the Results

The results of the magnetic properties, orientation and angle difference θ of the same density magnets obtained in Examples 1, 2, 3 and Comparative Examples 1, 2, and 3 are compared in Table 1.

TABLE 1

| | | Orien- | Orien- | orientation | orientation |
|---|---|---|---|---|---|
| | | tation | tation | angle | angle |
| | | degree | degree | deviation | deviation |
| | Br | at edge | at centre | at edge | at centre |
| Example 1 | 1.0% | 92.5% | 92.9% | 0.2 Degree | 0.1 Degree |
| Example 2 | 1.1% | 92.8% | 93.7% | 0.5 Degree | 0.1 Degree |
| Example 3 | 0.9% | 94.5% | 95.1% | 0.5 Degree | 0.2 Degree |
| Comparative | 3.1% | 88.1% | 90.0% | 3.0 Degree | 0.2 Degree |
| Example 1 | | | | | |
| Comparative | 4.0% | 80.0% | 91.5% | 4.0 Degree | 1.0 Degree |
| Example 2 | | | | | |
| Comparative | 5.5% | 68.2% | 87.1% | 15.2 Degree | 1.0 Degree |
| Example 3 | | | | | |

It can be seen from the comparison of Examples and the Comparative Examples that the radiating arc magnet manufactured by the process method and device of the present disclosure can improve the overall magnetic performance consistency and reduce the deviation of the orientation angle of each position. The orientation of the magnet can also be improved significant, and the distribution of the magnetic field lines of the magnet as a whole is consistent with the expected model design.

1. A molding device for the align pressing step of a manufacturing process of a radiation-oriented sintered arc-shaped Nd—Fe—B magnet, the molding device including a mold body comprising:
a) a mold main body provided with an arc-shaped cavity including a concave inner arc surface and a convex outer arc surface;
b) a first and a second magnetic conductive block located on both sides of the arc-shaped cavity, the first magnetic conductive block being located on the side of the inner arc surface, and the second magnetic conductive block being located on the side of the outer arc surface, wherein the centre points of the first magnetic conductive block, the arc-shaped cavity and the second magnetic conductive block lie on a common straight line; and
c) two symmetrically distributed uniform magnetic conductive plates being arranged between the outer arc surface of the arc-shaped cavity and the second magnetic conductive block.

2. The molding device of claim 1, wherein a surface of the first magnetic conductive block facing the inner arc surface is arc-shaped, and a radius of the arc shape is smaller than a radius of the inner arc surface in the arc-shaped cavity.

3. The molding device of claim 1, wherein a surface of the second magnetic conductive block facing the outer arc surface is bent, and a bending angle of the bent shape is 90 degrees.

4. The molding device of claim 1, wherein the two magnetic conductive plates are respectively located at the two ends of the outer arc surface of the arc-shaped cavity.

5. The molding device of claim 1, wherein a thickness W of the magnetic conductive plate satisfies the condition: 0.5 cavity thickness ≤W≤1.0 mold cavity thickness,
a length L of the magnetic conductive plate satisfies the condition: 0.2 inner arc length ≤L≤0.4 inner arc length, where the inner arc length L is the length of the inner arc surface of the arc-shaped cavity,
a side surface (S2) of the arc-shaped cavity is on the same plane as an outer side surface (S1) of the magnetic conductive plate, and
a thickness of the arc-shaped cavity is in the range of 5 mm to 25 mm.

6. The molding device of claim 1, wherein the molding device further includes an upper indenter and a lower indenter, the upper indenter being located directly above the arc-shaped cavity, and the lower indenter being located directly below the arc-shaped cavity.

7. The molding device of claim 2, wherein a surface of the second magnetic conductive block facing the outer arc surface is bent, and a bending angle of the bent shape is 90 degrees.

8. The molding device of claim 7, wherein the two magnetic conductive plates are respectively located at the two ends of the outer arc surface of the arc-shaped cavity.

9. The molding device of claim 8, wherein a thickness W of the magnetic conductive plate satisfies the condition: 0.5 cavity thickness ≤W≤1.0 mold cavity thickness,
a length L of the magnetic conductive plate satisfies the condition: 0.2 inner arc length ≤L≤0.4 inner arc length, where the inner arc length L is the length of the inner arc surface of the arc-shaped cavity,
a side surface (S2) of the arc-shaped cavity is on the same plane as an outer side surface (S1) of the magnetic conductive plate, and
a thickness of the arc-shaped cavity is in the range of 5 mm to 25 mm.

10. The molding device of claim 9, wherein the molding device further includes an upper indenter and a lower indenter, the upper indenter being located directly above the arc-shaped cavity, and the lower indenter being located directly below the arc-shaped cavity.

11. A method for preparing a radiation-oriented sintered arc-shaped Nd—Fe—B magnet, the method comprising in that order the steps of:
a) providing a Nd—Fe—B powder and the molding device as defined in claim 1;
b) performing a first sub-step of align pressing including filling the arc-shaped cavity of the molding device with a first powder loading of the Nd—Fe—B powder, performing a first magnetization of the Nd—Fe—B powder, and mold pressing the Nd—Fe—B powder to form a first green body;
c) performing a second sub-step of align pressing including filling the arc-shaped cavity of the molding device with a second powder loading of the Nd—Fe—B powder, performing a second magnetization of the Nd—Fe—B powder, and mold pressing the Nd—Fe—B powder to form a second green body; and
d) sintering and annealing the second green body to obtain an arc-shaped Nd—Fe—B magnet.

12. The method of claim 11, wherein in step b) a weight w1 of the first powder loading satisfies the relation: 0.2M≤w1≤0.5M, where M is the weight of the second green body;
a magnetic field T1 of the first magnetization satisfies the relation: 0.1 Tesla≤T1≤0.3 Tesla; and
a density p1 of the first green body after the mold pressing satisfies the relation: 0.8P≤p1≤0.9P, where P is the density of the second green body and P satisfies the condition 3.8 g/cm³≤P≤4.5 g/cm³.

13. The method of claim 12, wherein in step c)
a weight w2 of the second powder loading is w2=M−w1; and
a magnetic field T2 of the second magnetization satisfies the relation: 0.3 Tesla<T2≤2.5 Tesla.

14. A radiation-oriented sintered arc-shaped Nd—Fe—B magnet obtained by the method of claim 11.

15. The radiation-oriented sintered arc-shaped Nd—Fe—B magnet of claim 14, wherein
an orientation degree of the main phase of the sintered Nd—Fe—B arc-shaped magnet is above 92%,
an orientation angle of the radiation orientation and a target value deviate Δθ≤1 degree, and
an overall residual deviation of the magnet is ΔBr≤2%.
